(19) United States
(12) Patent Application Publication
(10) Pub. No.: US 2026/0333330 A1
(43) Pub. Date: Oct. 22, 2026

(54) CONTROL DEVICE, CONTROL METHOD, AND RECORDING MEDIUM

(71) Applicant: NEC Corporation, Tokyo (JP)

(72) Inventors: Shigeharu TSUKAGOSHI, Tokyo (JP); Hiroki TANAKA, Tokyo (JP); Minoru KOBAYASHI, Tokyo (JP)

(73) Assignee: NEC Corporation, Tokyo (JP)

(21) Appl. No.: 19/491,065

(22) PCT Filed: Jul. 1, 2024
(86) PCT No.: PCT/JP2024/023699

§ 371 Date: Dec. 8, 2025

(30) Foreign Application Priority Data
Jul. 14, 2023 (JP) 2023-115875

(51) Int. Cl. H04W 72/0453; H04B 11/00; H04B 13/02; H04W 64/00; H04W 72/541

(52) U.S. Cl. CPC H04W 72/0453; H04B 11/00; H04B 13/02; H04W 64/00; H04W 72/541

(57) ABSTRACT

In underwater communication using sound waves, when a use frequency is changed, communication efficiency decreases due to the change in the use frequency. Therefore, a control device estimates whether an influence of an interference wave that interferes with wireless communication using sound waves of a wireless communication device present underwater is continuous or transient based on a velocity of an interference source that generates the interference wave, and changes a use frequency of an interfered device to an interference mitigation frequency that is a frequency capable of reducing the influence of the interference wave in a case where the influence of the interference wave is estimated to be continuous, or continues the use of the use frequency of the interfered device in a case where the influence of the interference wave is estimated to be transient.

### TECHNICAL FIELD

The present invention relates to a control device, a control system, a control method, and a recording medium.

### BACKGROUND ART

It is considered to perform communication using sound waves underwater. Hereinafter, underwater communication using sound waves may be referred to as underwater sound wave communication.

Since an attenuation amount of radio waves is large underwater, sound waves are more suitable for communication than radio waves in deep water.

In recent years, a method has been known in which a control device on land or on water communicates with an underwater communication device via a base station floating on a water surface. In the method in which the control device communicates with the underwater communication device via the base station floating on the water surface, the communication between the base station and the communication device is performed by underwater sound wave communication. The communication between the base station and the control device is performed by radio wave communication, wired communication, or optical communication.

As related techniques, there are techniques described in PTL 1 to PTL 4.

### CITATION LIST

### Patent Literature

PTL 1: JP 2017-181448 A

PTL 2: JP 2016-215908 A

PTL 3: JP 2004-085223 A

PTL 4: JP 2001-147265 A

### SUMMARY OF INVENTION

### Technical Problem

However, in a case where an interference source occurs, there is a possibility that interference occurs in sound waves transmitted from a communication device or a base station and communication quality is deteriorated.

In order to avoid an influence of the interference, it is conceivable to change a use frequency of the wireless communication device during operation.

However, in a case where the use frequency is changed, a time during which communication is stopped occurs due to the change in the use frequency, decreasing efficiency of communication.

In view of the above-described problems, an object of the present invention is to provide a control device, a control system, a control method, and a recording medium capable of improving communication efficiency in underwater communication using sound waves.

### Solution to Problem

In one aspect of the present invention, a control device includes an estimation means for estimating whether an influence of an interference wave that interferes with wireless communication using sound waves of a wireless communication device present underwater is continuous or transient, based on a velocity of an interference source that generates the interference wave, and a control means for performing control to, in a case where it is estimated that the influence of the interference wave is continuous, change a use frequency used for the wireless communication by an interfered device that is a wireless communication device that is influenced by the interference wave and performs the wireless communication to an interference mitigation frequency that is a frequency capable of reducing the influence of the interference wave, and in a case where it is estimated that the influence of the interference wave is transient, continue the use of the use frequency of the interfered device.

In another aspect of the present invention, a control system includes an estimation means for estimating whether an influence of an interference wave that interferes with wireless communication using sound waves of a wireless communication device present underwater is continuous or transient, based on a velocity of an interference source that generates the interference wave, and a control means for performing control to, in a case where it is estimated that the influence of the interference wave is continuous, change a use frequency used for the wireless communication by an interfered device that is a wireless communication device that is influenced by the interference wave and performs the wireless communication to an interference mitigation frequency that is a frequency capable of reducing the influence of the interference wave, and in a case where it is estimated that the influence of the interference wave is transient, continue the use of the use frequency of the interfered device.

In another aspect of the present invention, a control method includes estimating whether an influence of an interference wave that interferes with wireless communication using sound waves of a wireless communication device present underwater is continuous or transient, based on a velocity of an interference source that generates the interference wave, and performing control to, in a case where it is estimated that the influence of the interference wave is continuous, change a use frequency used for the wireless communication by an interfered device that is a wireless communication device that is influenced by the interference wave and performs the wireless communication to an interference mitigation frequency that is a frequency capable of reducing the influence of the interference wave, and in a case where it is estimated that the influence of the interference wave is transient, continue the use of the use frequency of the interfered device.

In another aspect of the present invention, a computer-readable recording medium that records a control program causes a computer to implement an estimation function for estimating whether an influence of an interference wave that interferes with wireless communication using sound waves of a wireless communication device present underwater is continuous or transient, based on a velocity of an interference source that generates the interference wave, and a control function for performing control to, in a case where it is estimated that the influence of the interference wave is continuous, change a use frequency used for the wireless communication by an interfered device that is a wireless communication device that is influenced by the interference wave and performs the wireless communication to an interference mitigation frequency that is a frequency capable of reducing the influence of the interference wave, and in a case where it is estimated that the influence of the interference wave is transient, continue the use of the use frequency of the interfered device.

### ADVANTAGEOUS EFFECTS OF INVENTION

According to the above aspects of the present invention, it is possible to improve communication efficiency in underwater communication using sound waves.

### BRIEF DESCRIPTION OF DRAWINGS

FIG. 1 is a diagram illustrating a configuration example of a control device according to a first example embodiment of the present invention.

FIG. 2 is a diagram illustrating an example of an operation flow of the control device according to the first example embodiment of the present invention.

FIG. 3 is a diagram illustrating a configuration example of a communication system including a control device according to a second example embodiment of the present invention.

FIG. 4 is a diagram illustrating a configuration example of the control device according to the second example embodiment of the present invention.

FIG. 5 is a diagram illustrating an example of an operation flow of a control device according to the second example embodiment and a third example embodiment of the present invention.

FIG. 6 is a diagram illustrating a configuration example of a communication system including the control device according to the third example embodiment of the present invention.

FIG. 7 is a diagram illustrating a configuration example of the control device according to the third example embodiment of the present invention.

FIG. 8 is a diagram illustrating a hardware configuration example of each example embodiment of the present invention.

### EXAMPLE EMBODIMENT

### First Example Embodiment

A first example embodiment of the present invention is described. A specific example of a control device 10 in the first example embodiment is a control device 20 in a second example embodiment and a control device 30 in a third example embodiment described below.

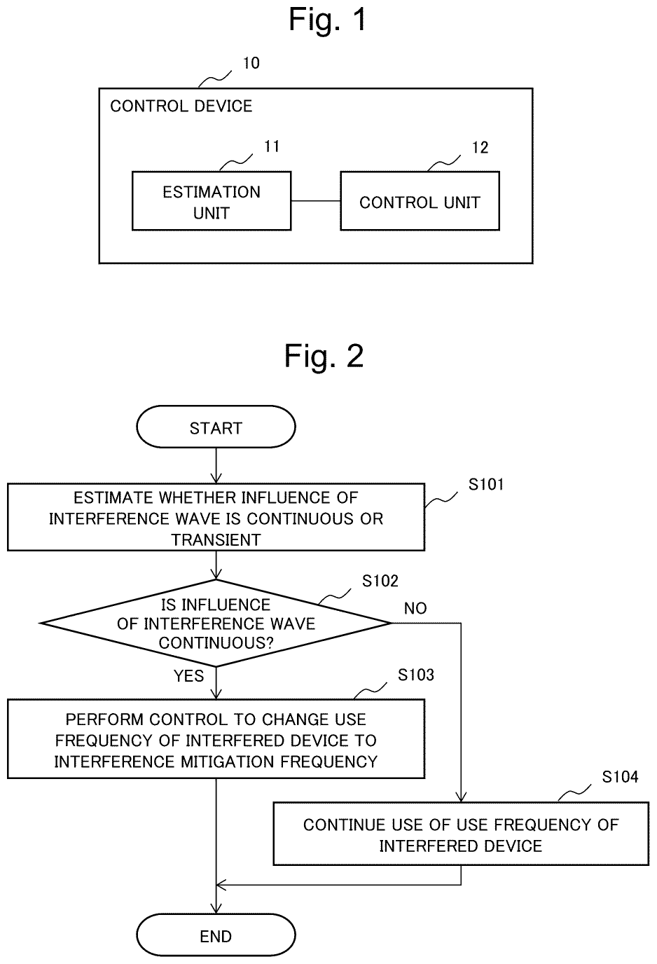

FIG. 1 illustrates a configuration example of the control device 10 of the present example embodiment. The control device 10 includes an estimation unit 11 and a control unit 12.

The estimation unit 11 estimates whether an influence of an interference wave is continuous or transient based on a velocity of an interference source. The interference source emits an interference wave that interferes with wireless communication using sound waves of a wireless communication device present underwater. The interference wave is a wave that deteriorates quality of the wireless communication of the wireless communication device. The interference source is an object that emits an interference wave.

In a case where it is estimated that the influence of the interference wave is continuous, the control unit 12 performs control to change a use frequency used by an interfered device for wireless communication to an interference mitigation frequency. The interfered device is a wireless communication device that is influenced by the interference wave and performs wireless communication. The interference mitigation frequency is a frequency that can reduce the influence of the interference wave.

In addition, in a case where it is estimated that the influence of the interference wave is transient, the control unit 12 continues the use of the use frequency of the interfered device.

Next, FIG. 2 illustrates an example of an operation flow of the control device 10 of the present example embodiment.

The estimation unit 11 estimates whether the influence of the interference wave is continuous or transient based on the velocity of the interference source (step S101).

In a case where it is estimated that the influence of the interference wave is continuous (YES in step S102), the control unit 12 performs control to change the use frequency of the interfered device to the interference mitigation frequency (step S103).

In a case where it is estimated that the influence of the interference wave is transient (NO in step S102), the control unit 12 continues the use of the use frequency of the interfered device (step S104).

As described above, in the first example embodiment of the present invention, the control device 10 includes the estimation unit 11 and the control unit 12. The estimation unit 11 estimates whether an influence of an interference wave is continuous or transient based on a velocity of an interference source. The interference source emits an interference wave that interferes with wireless communication using sound waves of a wireless communication device present underwater. In the case where it is estimated that the influence of the interference wave is continuous, the control unit 12 performs control to change the use frequency of the interfered device to the interference mitigation frequency. The interfered device is a wireless communication device that is influenced by the interference wave and performs wireless communication. The interference mitigation frequency is a frequency that can reduce the influence of the interference wave. In the case where it is estimated that the influence of the interference wave is transient, the control unit 12 continues the use of the use frequency of the interfered device.

Consequently, in the case where it is estimated that the influence of the interference wave is transient, the use of the use frequency is continued. As a result, in the case where the influence of the interference wave is transient, a decrease in communication efficiency due to the change in the use frequency can be reduced. Therefore, it is possible to improve communication efficiency in underwater communication using sound waves.

In the case where it is estimated that the influence of the interference wave is continuous, the use frequency of the interfered device is changed to the interference mitigation frequency. Therefore, it is possible to reduce the influence of the interference wave.

### Second Example Embodiment

Next, a second example embodiment of the present invention is described. The specific example of the control device 10 in the first example embodiment is a control device 20 in the second example embodiment.

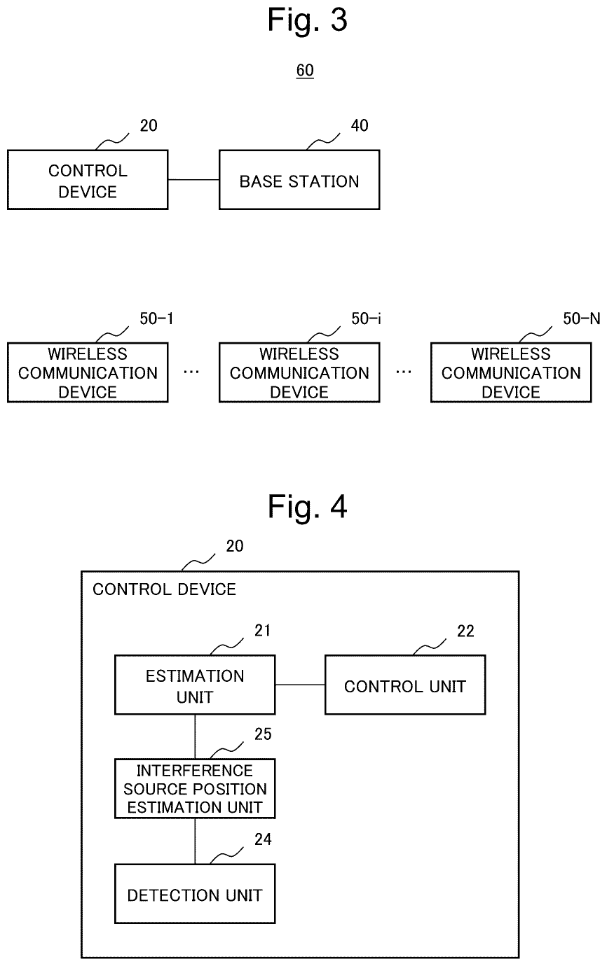

FIG. 3 illustrates a configuration example of a communication system 60 including the control device 20 of the present example embodiment. The communication system 60 includes the control device 20, a base station 40, and a wireless communication device 50-i (i is an integer of 1 to N, and N is an integer of 1 or more).

The base station 40 is located on water. The base station 40 can perform wireless communication using sound waves with the wireless communication device 50-i.

The wireless communication device 50-i is present underwater. The wireless communication device 50-i can perform wireless communication using sound waves with the base station 40. The wireless communication device 50-i can communicate with the control device 20 via the base station 40. Note that the wireless communication devices 50-1 to 50-N may be collectively referred to as a wireless communication device 50.

The control device 20 is connected to the base station 40. The control device 20 is located on water or on land. The control device 20 can perform wireless communication using radio waves or wired communication with the base station 40. In addition, the control device 20 controls a use frequency of the wireless communication device 50-i.

The use frequency is a frequency to be used by the wireless communication device 50-i for wireless communication using sound waves with the base station 40. Note that the wireless communication may be communication based on a band signal. In this case, the use frequency may be a frequency band. When the wireless communication is communication based on a band signal, the term “frequency” refers to a “frequency band”.

Next, FIG. 4 illustrates a configuration example of the control device 20 of the present example embodiment. The control device 20 includes an estimation unit 21, a control unit 22, a detection unit 24, and an interference source position estimation unit 25.

The detection unit 24 detects occurrence of an interference wave with respect to wireless communication performed by the wireless communication device 50. The detection unit 24 can detect the occurrence of the interference wave by any method. The method of detecting the occurrence of the interference wave is described below.

The interference wave is a wave that deteriorates quality of the wireless communication of the wireless communication device 50. For example, a wave having a frequency close to a use frequency for the wireless communication of the wireless communication device 50 can be an interference wave. In the case of wireless communication using sound waves, sound waves used in communication performed by other service providers, natural sound, sound of construction conducted on water, on land, or underwater, sound emitted by a ship, and the like can also be interference waves.

The interference source position estimation unit 25 estimates position information of the interference source that emits the interference wave detected by the detection unit 24. A method of estimating the position of the interference source is described below.

The interference source is an object that emits an interference wave. For example, a device that performs communication using sound waves, an underwater living organism, construction equipment, a ship, and the like can also be interference sources.

The estimation unit 21 estimates whether the influence of the interference wave is continuous or transient based on a velocity of the interference source of the interference wave with respect to wireless communication. In the present example embodiment, in a case where the detection unit 24 detects occurrence of interference with the wireless communication performed by the wireless communication device 50, the estimation unit 21 the estimation unit 21 estimates whether the influence of the interference wave is continuous or transient.

For example, in a case where the velocity of the interference source is greater than a predetermined velocity, the estimation unit 21 estimates that the influence of the interference wave is transient. In a case where the velocity of the interference source is equal to or less than the predetermined velocity, the estimation unit 21 estimates that the influence of the interference wave is continuous. Furthermore, also in a case where the velocity of the interference source decreases with time, the estimation unit 21 may further estimate that the influence of the interference wave is continuous.

Here, the predetermined velocity may be, for example, a velocity set based on a time during which communication is stopped due to the change in the use frequency. In a case where the wireless communication device 50 changes the use frequency, the wireless communication is stopped, the use frequency is changed, and wireless communication at the changed frequency is started, resulting in occurrence of the time during which the communication is stopped. For example, the predetermined velocity may be a velocity at which the interference source moves away to a position at which the influence of the interference wave is reduced in a time shorter than the time during which the communication is stopped.

Furthermore, for example, the estimation unit 21 can estimate the velocity by the temporal change in the position of the interference source estimated by the interference source position estimation unit 25. Furthermore, the estimation unit 21 can grasp that the interference source is moving, based on a change in an incoming direction of the interference wave.

Furthermore, for example, the estimation unit 21 may estimate the continuity of the interference source by using position information of a ship. The estimation unit 21 may receive the position information of the ship from a server (not illustrated) that provides the information. The information provided from the server may be, for example, information by an automatic identification system (AIS). In addition, the position information of the ship may be position information of the ship visually confirmed by a surveillance staff on the land. In addition, the position information of the ship may include a history of past position information.

In this case, the estimation unit 21 estimates the ship serving as the interference source, based on the position information of the ship and the position of the interference source. For example, the estimation unit 21 may estimate a ship present within a predetermined range from the position of the interference source as the interference source. The position of the interference source is estimated by the interference source position estimation unit 25. In a case where equal to or more than two ships are present within the predetermined range from the position of the interference source, the estimation unit 21 may narrow down ships estimated as candidates for the interference source, based on the temporal change in the position of the interference source.

The estimation unit 21 uses a velocity of the ship estimated as the interference source as the velocity of the interference source. For example, the estimation unit 21 can estimate the velocity of the interference source by a temporal change in the position information of the ship estimated as the interference source. Further, the estimation unit 21 may use velocity information of the ship included in the information by the AIS as the velocity information of the interference source.

Note that the interference source may not be a ship. Therefore, the estimation unit 21 may not be able to estimate the ship serving as the interference source. For example, there may be no ship within the predetermined range from the position of the interference source. Therefore, in a case where the estimation unit 21 cannot estimate the ship serving as the interference source, it is preferable to estimate the velocity of the interference source by another method.

In the case where it is estimated that the influence of the interference wave is continuous, the control unit 22 performs control to change a use frequency of an interfered device to an interference mitigation frequency. The interfered device is the wireless communication device 50 influenced by the interference wave. The interference mitigation frequency is a frequency that can reduce the influence of the interference wave.

The control unit 22 can determine the interference mitigation frequency by any method. For example, in a case where equal to or more than two frequencies that can be used for wireless communication are prepared, the control unit 22 may set, as the interference mitigation frequency, a frequency different from the frequency influenced by the interference among the usable frequencies. In addition, for example, in a case where equal to or more than three frequencies that can be used for wireless communication are prepared, the control unit 22 may set, as the interference mitigation frequency, a frequency having the most different value from the frequency influenced by the interference among the usable frequencies.

Furthermore, in a case where the interference source is detected by the control device 20, the control unit 22 may estimate the interfered device based on the position of the interference source. For example, the control unit 22 may estimate the wireless communication device 50 present within the predetermined range from the interference source as the interfered device.

Furthermore, in a case where the interference source is detected by the wireless communication device 50-i, the control unit 22 may set the wireless communication device 50-i as the interfered device.

The control unit 22 instructs the interfered device to change the use frequency to the interference mitigation frequency. At this time, the interfered device may not be able to perform wireless communication using the original use frequency due to the influence of interference. In this case, the interfered device and the base station 40 may perform communication at a spare frequency.

The interfered device that has received the instruction to change the use frequency changes the use frequency to the instructed interference mitigation frequency. When receiving the change instruction, the interfered device may change the use frequency to the interference mitigation frequency stored in advance.

In addition, in the case where it is estimated that the influence of the interference wave is transient, the control unit 22 continues the use of the use frequency of the interfered device. For example, the control unit 22 does not perform control to change the use frequency of the interfered device to the interference mitigation frequency.

In a case where a sound emitted by a moving interference source (such as a ship) is a cause of interference, there may be a case where communication efficiency is better as a result of waiting for the interference source to move away and the interference to be resolved rather than changing the use frequency of the wireless communication device 50. In the case where it is estimated that the influence of the interference wave is transient, the control unit 22 of the present example embodiment can suppress the occurrence of the time during which communication is stopped due to the change in the use frequency, by continuing the use of the use frequency. Therefore, in the case where the influence of the interference wave is transient, since the decrease in communication efficiency due to the change in the use frequency can be reduced, it is possible to improve communication efficiency.

In the case where it is estimated that the influence of the interference wave is transient, the control unit 22 may further temporarily stop the wireless communication between the base station 40 and the interfered device. Furthermore, in a case where the wireless communication is temporarily stopped, the control unit 22 may restart the wireless communication after elapse of a time until the influence of the interference wave is reduced. For example, the control unit 22 can estimate a time until the interference source moves away and the influence of the interference wave is reduced from the estimated velocity of the interference source. Furthermore, in a case where the influence of the interference wave continues even when the wireless communication is restarted, the control unit 22 may restart the wireless communication after a predetermined waiting time elapses.

Next, the method of detecting the occurrence of the interference wave is described. As the method of detecting the occurrence of the interference wave, there is a method of detecting the occurrence based on a sound wave received by the base station 40 and a method of detecting the occurrence based on a sound wave received by the wireless communication device 50.

First, the method of detecting the interference wave based on the sound wave received by the base station 40 is described.

In this case, the base station 40 transmits information of the received sound wave to the control device 20. The information of the sound wave includes information of the incoming direction of the sound wave and information of a frequency of the sound wave. The base station 40 does not necessarily transmit sound wave information of sound waves used in communications with the wireless communication devices 50-1 to 50-N or sound waves having frequencies that do not influence the use frequencies of the wireless communication devices 50-1 to 50-N.

For example, the control device 20 can determine that an interference wave has occurred when the base station 40 receives any of the following sound waves.
A sound wave coming from a direction in which the wireless communication devices 50-1 to 50-N are not present
A sound wave coming from the direction in which the wireless communication devices 50-1 to 50-N are present, but having a frequency different from use frequencies of the wireless communication devices present in the direction
Sound wave with unknown identification information

Next, the method of detecting the interference wave based on the sound wave received by the wireless communication device 50-i is described.

In this case, the wireless communication device 50-i transmits information of the received sound wave to the control device 20 via the base station 40. The information of the sound wave includes information of the incoming direction of the sound wave and information of a frequency of the sound wave. Note that the wireless communication device 50-i does not necessarily transmit sound wave information of the sound wave used in the communication with the base station 40 or the sound waves having the frequencies that do not influence the use frequencies of the wireless communication devices 50-1 to 50-N.

In addition, when being influenced by the interference wave, the wireless communication device 50-i cannot communicate at the original use frequency. Therefore, in that case, the wireless communication device 50-i communicates with the base station 40 at a frequency that is not influenced by the interference wave among spare frequencies.

Next, the method of estimating the position of the interference source is described. The position of the interference source is estimated by the interference source position estimation unit 25.

For example, the interference source position estimation unit 25 receives information of the interference wave received by the base station 40 from the base station 40. The information of the interference wave includes information of an incoming direction and a frequency of the interference wave. In addition, the interference source position estimation unit 25 receives information of the interference wave received by the wireless communication device 50-i from the wireless communication device 50-i. Then, the interference source position estimation unit 25 estimates the position of the interference source by using information of an interference wave estimated to be an interference wave from the same interference source among the received information of the interference wave. For example, the interference source position estimation unit 25 can determine, as the position of the interference source, an intersection of straight lines extended in the incoming direction of the interference wave from the position of the device (the base station 40 or the wireless communication device 50-i) having received the interference wave. The interference source position estimation unit 25 may regard, for example, an interference wave of the same frequency as the interference wave from the same interference source.

The position of the wireless communication device 50-i may be measured based on an acceleration sensor included in the wireless communication device 50-i.

Furthermore, the interference source position estimation unit 25 can estimate the position of the wireless communication device 50-i based on, for example, the incoming direction of the sound wave emitted by the wireless communication device 50-i with respect to the base station 40. For example, the interference source position estimation unit 25 receives, from the base station 40, information of the incoming direction of the sound wave emitted by the wireless communication device 50-i. In addition, the interference source position estimation unit 25 receives information of the position (depth) of the wireless communication device 50-i in the vertical direction from the wireless communication device 50-i via the base station 40. Then, the interference source position estimation unit 25 can estimate the position of the wireless communication device 50-i based on the information of the incoming direction and the information of the position (depth) in the vertical direction. In this case, the wireless communication device 50-i includes a pressure (depth) sensor.

The interference source position estimation unit 25 may further estimate the position of the interference wave based on received signal intensity of the interference wave. In this case, the information of the interference wave further includes information of the received signal intensity at the device that has received the interference wave.

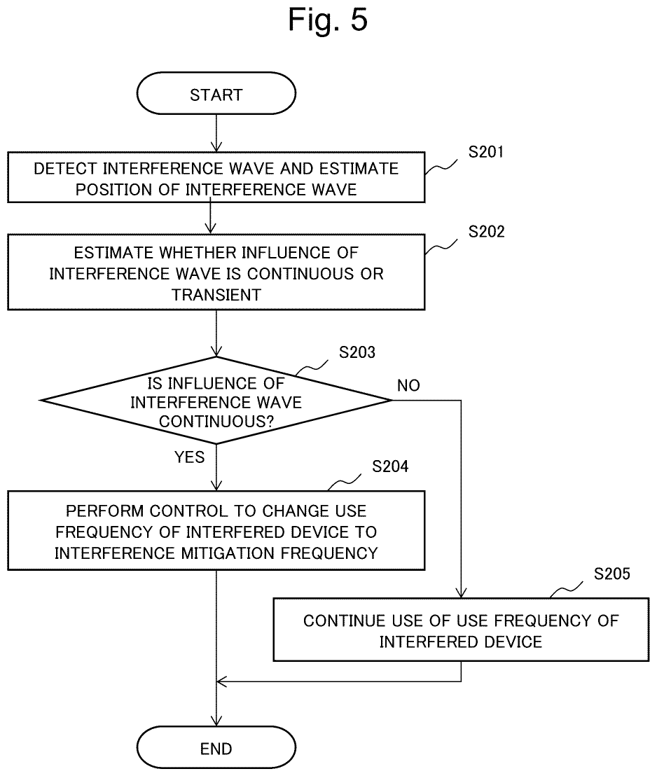

Next, FIG. 5 illustrates an example of an operation flow of the control device 20.

The detection unit 24 detects the occurrence of the interference wave with respect to the wireless communication performed by the wireless communication device 50. The interference source position estimation unit 25 estimates the position information of the interference source that emits the interference wave detected by the detection unit 24 (step S201).

The estimation unit 21 estimates whether the influence of the interference wave is continuous or transient based on the velocity of the interference source of the interference wave with respect to wireless communication (step S202). In the present example embodiment, in a case where the detection unit 24 detects the occurrence of the interference with the wireless communication device 50, the estimation unit 21 estimates whether the influence of the interference wave is continuous or transient.

In the case where it is estimated that the influence of the interference wave is continuous (YES in step S203), the control unit 22 performs control to change the use frequency of the interfered device to the interference mitigation frequency (step S204).

In the case where it is estimated that the influence of the interference wave is transient (NO in step S203), the control unit 22 continues the use of the use frequency of the interfered device (step S205).

As described above, in the second example embodiment of the present invention, the control device 20 includes the estimation unit 21 and the control unit 22. The estimation unit 21 estimates whether the influence of the interference wave is continuous or transient based on the velocity of the interference source. The interference source emits an interference wave that interferes with wireless communication using sound waves of a wireless communication device present underwater. In the case where it is estimated that the influence of the interference wave is continuous, the control unit 22 performs control to change a use frequency of an interfered device to an interference mitigation frequency. The interfered device is a wireless communication device that is influenced by the interference wave and performs wireless communication. The interference mitigation frequency is a frequency that can reduce the influence of the interference wave. In the case where it is estimated that the influence of the interference wave is transient, the control unit 22 continues the use of the use frequency of the interfered device.

Consequently, in the case where it is estimated that the influence of the interference wave is transient, the use of the use frequency is continued. As a result, in the case where the influence of the interference wave is transient, a decrease in communication efficiency due to the change in the use frequency can be reduced. Therefore, it is possible to improve communication efficiency in underwater communication using sound waves.

In the case where it is estimated that the influence of the interference wave is continuous, the use frequency of the interfered device is changed to the interference mitigation frequency. Therefore, it is possible to reduce the influence of the interference wave.

In the case where the velocity of the interference source is greater than the predetermined velocity, the estimation unit 21 estimates that the influence of the interference wave is transient. As a result, it is possible to estimate that the influence is transient for the interference wave in which a time until the interference source comes out of the range of the influence on the wireless communication device 50 is short.

In a case where the velocity of the interference source is equal to or less than the predetermined velocity, the estimation unit 21 estimates that the influence of the interference wave is continuous. As a result, it is possible to estimate that the influence is continuous for the interference wave in which the time until the interference source comes out of the range of the influence on the wireless communication device 50 is long.

Furthermore, in the case where the velocity of the interference source decreases with time, the estimation unit 21 may further estimate that the influence of the interference wave is continuous. As a result, it is possible to estimate that the influence is continuous for the interference wave in which the time until the interference source comes out of the range of the influence on the wireless communication device 50 is long.

Furthermore, the control device 20 further includes the interference source position estimation unit 25 that estimates the position of the interference source. Furthermore, the estimation unit 21 estimates the velocity of the interference source based on the temporal change in the position of the interference source. As a result, the control device 20 can estimate the velocity of the interference source.

Furthermore, the control device 20 further includes the interference source position estimation unit 25 that estimates the position of the interference source. In addition, the estimation unit 21 estimates the ship serving as the interference source based on the position information of the ship and the position of the interference source, and uses the velocity of the ship estimated as the interference source as the velocity of the interference source. As a result, in the case where the interference source is the ship, the control device 20 can more accurately estimate the velocity of the interference source.

### Third Example Embodiment

Next, a third example embodiment of the present invention is described. A specific example of the control device 10 in the first example embodiment is a control device 30 in the third example embodiment.

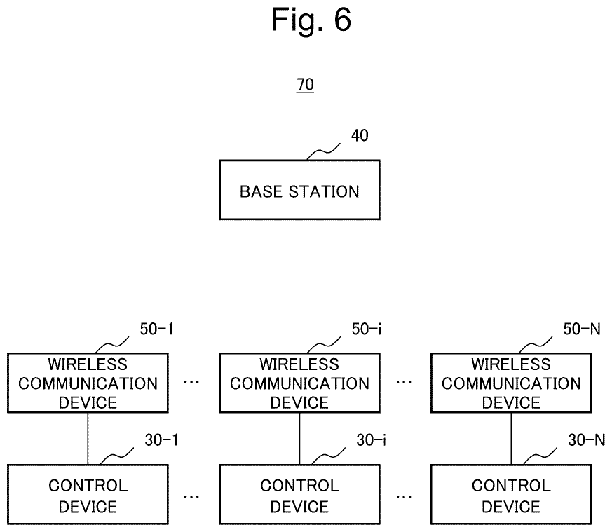

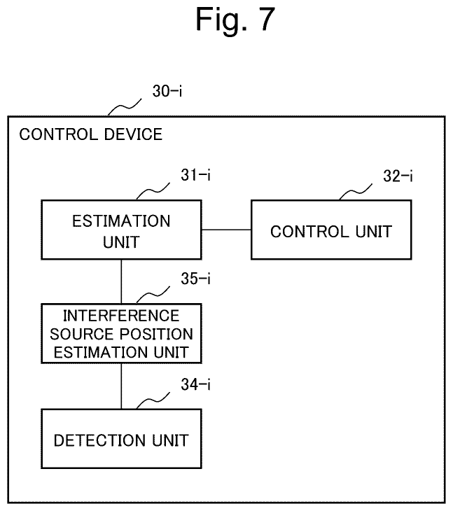

FIG. 6 illustrates a configuration example of a communication system 70 including the control device 30 of the present example embodiment. The communication system 60 includes a base station 40, wireless communication devices 50-i (i is an integer of 1 to N, and N is an integer of 1 or more), and control devices 30-i. Each of the control devices 30-i is connected to a corresponding one of the wireless communication devices 50-i. Control devices 30-1 to 30-N may be collectively referred to as the control device 30.

Since the base station 40 and the wireless communication device 50 are similar to those of the second example embodiment, the description thereof is omitted.

The control device 30-i is connected to the wireless communication device 50-i. The control device 30-i is mounted on, for example, the same unmanned undersea vehicle (UUV) as the wireless communication device 50-i. In addition, the control device 30-i controls a use frequency of the wireless communication device 50-i.

Next, FIG. 7 illustrates a configuration example of the control device 30-i of the present example embodiment. The control device 30-i includes an estimation unit 31-i, a control unit 32-i, a detection unit 34-i, and an interference source position estimation unit 35-i.

The detection unit 34-i detects occurrence of an interference wave with respect to wireless communication performed by the wireless communication device 50-i. The detection unit 34-i can detect the occurrence of the interference wave by any method. For example, in the present example embodiment, the detection unit 34-i detects the interference wave based on a sound wave received by the wireless communication device 50-i connected to the control device 30-i. Note that the detection unit 34-i may not detect, as the interference wave, a sound wave that does not influence a sound wave used for wireless communication between the wireless communication device 50-i and the base station 40.

The interference source position estimation unit 35-i estimates position information of an interference source that emits the interference wave detected by the detection unit 34-i. A method of estimating the position of the interference source is described below.

The estimation unit 31-i estimates whether an influence of the interference wave is continuous or transient based on a velocity of the interference source of the interference wave with respect to wireless communication. Since the estimation method is the same as that of the second example embodiment, the description thereof is omitted.

In a case where it is estimated that the influence of the interference wave is continuous, the control unit 32-i performs control to change a use frequency of an interfered device (wireless communication device 50-i) to an interference mitigation frequency. In the case of the present example embodiment, since it is estimated whether the influence of the interference wave is continuous or transient in the case where the detection unit 34-i detects the interference wave with respect to the wireless communication performed by the wireless communication device 50-i, the interfered device to be controlled is the wireless communication device 50-i.

The control unit 32-i instructs the interfered device (wireless communication device 50-i) to change the use frequency to the interference mitigation frequency. The interfered device that has received the instruction to change the use frequency changes the use frequency to the instructed interference mitigation frequency. When receiving the change instruction, the interfered device may change the use frequency to the interference mitigation frequency stored in advance.

In a case where it is estimated that the influence of the interference wave is transient, the control unit 32-i continues the use of the use frequency of the interfered device. For example, the control unit 32-i does not perform control to change the use frequency of the interfered device to the interference mitigation frequency.

In the case where it is estimated that the influence of the interference wave is transient, the control unit 32-i may further temporarily stop the wireless communication from the wireless communication device 50-i to the base station 40.

Next, a method of estimating a position of the interference source is described. The position of the interference source is estimated by the interference source position estimation unit 35-i.

For example, the interference source position estimation unit 35-i estimates the position of the interference source based on an incoming direction of the interference wave with respect to the wireless communication device 50-i and the position of the wireless communication device 50-i. At this time, the position of the interference source may be in a range in which the interference source may be present.

Furthermore, the interference source position estimation unit 35-i may further estimate the position of the interference wave based on received signal intensity of the interference wave.

The position of the wireless communication device 50-i may be measured based on an acceleration sensor included in the wireless communication device 50-i.

Furthermore, the interference source position estimation unit 35-i can also estimate the position of the wireless communication device 50-i based on, for example, an incoming direction of a sound wave emitted by the base station 40 with respect to the wireless communication device 50-i. For example, the interference source position estimation unit 35-i receives, from the wireless communication device 50-i, information of the incoming direction of the sound wave emitted by the base station 40. In addition, the interference source position estimation unit 35-i receives information of the position (depth) of the wireless communication device 50-i in the vertical direction from the wireless communication device 50-i. Then, the interference source position estimation unit 35-i can estimate the position of the wireless communication device 50-i based on the information of the incoming direction, the information of the position (depth) in the vertical direction, and the position information of the base station 40. In this case, the wireless communication device 50-i includes a pressure (depth) sensor.

Next, an example of an operation flow of the control device 30-i is described with reference to FIG. 5.

The detection unit 34-i detects the occurrence of the interference wave with respect to the wireless communication device 50-i. The interference source position estimation unit 35-i estimates the position information of the interference source that emits the interference wave detected by the detection unit 34-i (step S201).

The estimation unit 31-i estimates whether the influence of the interference wave is continuous or transient based on the velocity of the interference source of the interference wave with respect to wireless communication (step S202). In the present example embodiment, in a case where the detection unit 34-i detects the occurrence of the interference with the wireless communication device 50-i, the estimation unit 31-i the estimation unit 31-i estimates whether the influence of the interference wave is continuous or transient.

In the case where it is estimated that the influence of the interference wave is continuous (YES in step S203), the control unit 32-i performs control to change the use frequency of the interfered device (wireless communication device 50-i) to the interference mitigation frequency (step S204).

In the case where it is estimated that the influence of the interference wave is transient (NO in step S203), the control unit 32-i continues the use of the use frequency of the interfered device (step S205).

As described above, in the third example embodiment of the present invention, the control device 30-i includes the estimation unit 31-i and the control unit 32-i. The estimation unit 31-i estimates whether the influence of the interference wave is continuous or transient based on the velocity of the interference source. The interference source emits an interference wave that interferes with wireless communication using sound waves of a wireless communication device present underwater. In the case where it is estimated that the influence of the interference wave is continuous, the control unit 32-i performs control to change the use frequency of the interfered device to the interference mitigation frequency. The interfered device is a wireless communication device that is influenced by the interference wave and performs wireless communication. The interference mitigation frequency is a frequency that can reduce the influence of the interference wave. In a case where it is estimated that the influence of the interference wave is transient, the control unit 32-i continues the use of the use frequency of the interfered device.

Consequently, in the case where it is estimated that the influence of the interference wave is transient, the use of the use frequency is continued. As a result, in the case where the influence of the interference wave is transient, a decrease in communication efficiency due to the change in the use frequency can be reduced. Therefore, it is possible to improve communication efficiency in underwater communication using sound waves.

In the case where it is estimated that the influence of the interference wave is continuous, the use frequency of the interfered device is changed to the interference mitigation frequency. Therefore, it is possible to reduce the influence of the interference wave.

### [Hardware Configuration Example]

A configuration example of a hardware resource is described that enables one information processing device (computer) to implement the control device (10, 20, 30) in each example embodiment of the present invention described above. Note that the control device may be implemented physically or functionally by using at least two information processing devices. The control device may also be implemented as a dedicated device. In addition, only some functions of the control device may be implemented by using the information processing device. In addition, at least some functions of the control device may be implemented on a cloud.

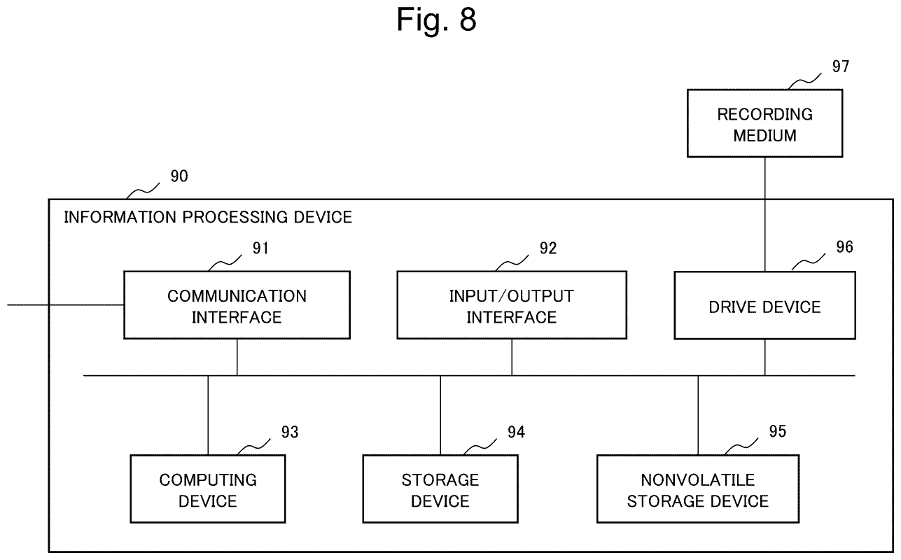

FIG. 8 is a diagram schematically illustrating a hardware configuration example of the information processing device capable of implementing the control device according to each example embodiment of the present invention. An information processing device 90 includes a communication interface 91, an input/output interface 92, a computing device 93, a storage device 94, a nonvolatile storage device 95, and a drive device 96.

For example, the control unit 12 in FIG. 1 can be implemented by the communication interface 91 and the computing device 93. The estimation unit 11 can be implemented by the computing device 93.

The communication interface 91 is a communication means for the control device of each example embodiment to communicate with an external device in a wired or/and wireless manner. Note that, when the control device is implemented by using at least two information processing devices, the devices may be connected in such a way as to be able to communicate with each other via the communication interface 91 between the devices.

The input/output interface 92 is a man-machine interface such as a keyboard as an example of an input device and a display as an output device.

The computing device 93 is implemented by a general-purpose central processing unit (CPU), an arithmetic processing device such as a microprocessor, or a plurality of electric circuits. For example, the computing device 93 can read various programs stored in the nonvolatile storage device 95 into the storage device 94 and execute processing according to the read program.

The storage device 94 is a memory device such as a random access memory (RAM) that can be referred to from the computing device 93, and stores programs, various data, and the like. The storage device 94 may be a volatile memory device.

The nonvolatile storage device 95 is a nonvolatile storage device such as a read only memory (ROM) or a flash memory, and can store various programs, data, and the like.

The drive device 96 is, for example, a device that processes reading and writing of data on a recording medium 97 described below.

The recording medium 97 is any recording medium capable of recording data, for example, an optical disk, a magneto-optical disk, or a semiconductor flash memory.

Each example embodiment of the present invention may be implemented, for example, by configuring a control device with the information processing device 90 illustrated in FIG. 8 and supplying the control device with a program capable of implementing the functions described in each example embodiment.

In this case, the computing device 93 can execute the program supplied to the control device to implement the example embodiment. In addition, not all but some of the functions of the control device can also be configured by the information processing device 90.

Furthermore, the program may be recorded in the recording medium 97, and the control device may be configured such that the program is appropriately stored in the nonvolatile storage device 95 at a shipment stage, an operation stage, or the like of the control device. In this case, a supply method of the program may employ a method of installing the program in the control device by using an appropriate jig in a manufacturing stage before shipment, an operation stage, or the like.

In addition, the supply method of the program may employ a general procedure such as a method of downloading the program from the outside via a communication line such as the Internet.

Some or all of the above-described example embodiments may be described as the following Supplementary Notes, but are not limited to the following.

### Supplementary Note 1

A control device including:
an estimation means for estimating whether an influence of an interference wave that interferes with wireless communication using sound waves of a wireless communication device present underwater is continuous or transient, based on a velocity of an interference source that generates the interference wave; and
a control means for performing control to, in a case where it is estimated that the influence of the interference wave is continuous, change a use frequency used for the wireless communication by an interfered device that is a wireless communication device that is influenced by the interference wave and performs the wireless communication to an interference mitigation frequency that is a frequency capable of reducing the influence of the interference wave, and
in a case where it is estimated that the influence of the interference wave is transient, continue the use of the use frequency of the interfered device.

### Supplementary Note 2

The control device according to Supplementary Note 1, wherein
the estimation means estimates that the influence of the interference wave is transient in a case where the velocity of the interference source is greater than a predetermined velocity.

### Supplementary Note 3

The control device according to Supplementary Note 2, wherein
the estimation means estimates that the influence of the interference wave is continuous in a case where the velocity of the interference source is equal to or less than the predetermined velocity.

### Supplementary Note 4

The control device according to Supplementary Note 3, wherein
the estimation means estimates that the influence of the interference wave is continuous in a case where the velocity of the interference source further decreases with time.

### Supplementary Note 5

The control device according to any one of Supplementary Notes 1 to 4, further including
an interference source position estimation means for estimating a position of the interference source, wherein
the estimation means estimates the velocity of the interference source by a temporal change in the position of the interference source.

### Supplementary Note 6

The control device according to any one of Supplementary Notes 1 to 4, further including
an interference source position estimation means for estimating a position of the interference source, wherein
the estimation means estimates a ship serving as the interference source based on position information of the ship and the position of the interference source, and uses a velocity of the ship estimated as the interference source as the velocity of the interference source.

### Supplementary Note 7

A control system including:
an estimation means for estimating whether an influence of an interference wave that interferes with wireless communication using sound waves of a wireless communication device present underwater is continuous or transient, based on a velocity of an interference source that generates the interference wave; and
a control means for performing control to, in a case where it is estimated that the influence of the interference wave is continuous, change a use frequency used for the wireless communication by an interfered device that is a wireless communication device that is influenced by the interference wave and performs the wireless communication to an interference mitigation frequency that is a frequency capable of reducing the influence of the interference wave, and
in a case where it is estimated that the influence of the interference wave is transient, continue the use of the use frequency of the interfered device.

### Supplementary Note 8

A control method including:
estimating whether an influence of an interference wave that interferes with wireless communication using sound waves of a wireless communication device present underwater is continuous or transient, based on a velocity of an interference source that generates the interference wave; and
performing control to, in a case where it is estimated that the influence of the interference wave is continuous, change a use frequency used for the wireless communication by an interfered device that is a wireless communication device that is influenced by the interference wave and performs the wireless communication to an interference mitigation frequency that is a frequency capable of reducing the influence of the interference wave, and
in a case where it is estimated that the influence of the interference wave is transient, continue the use of the use frequency of the interfered device.

### Supplementary Note 9

The control method according to Supplementary Note 8, wherein
the influence of the interference wave is estimated to be transient in a case where the velocity of the interference source is greater than a predetermined velocity.

### Supplementary Note 10

A computer-readable recording medium that records a control program for causing a computer to implement:
an estimation function for estimating whether an influence of an interference wave that interferes with wireless communication using sound waves of a wireless communication device present underwater is continuous or transient, based on a velocity of an interference source that generates the interference wave; and
a control function for performing control to, in a case where it is estimated that the influence of the interference wave is continuous, change a use frequency used for the wireless communication by an interfered device that is a wireless communication device that is influenced by the interference wave and performs the wireless communication to an interference mitigation frequency that is a frequency capable of reducing the influence of the interference wave, and
in a case where it is estimated that the influence of the interference wave is transient, continue the use of the use frequency of the interfered device.

While the invention of the present application has been particularly shown and described with reference to example embodiments thereof, the invention of the present application is not limited to these example embodiments. It will be understood by those of ordinary skill in the art that various changes in form and details may be made therein without departing from the spirit and scope of the invention of the present application as defined by the claims.

This application is based upon and claims the benefit of priority from Japanese patent application No. 2023-115875, filed on Jul. 14, 2023, the disclosure of which is incorporated herein in its entirety by reference.

### REFERENCE SIGNS LIST

10, 20, 30-i CONTROL DEVICE
11, 21, 31-i estimation unit
12, 22, 32-i CONTROL UNIT
24, 34-i detection unit
25, 35-i interference source position estimation unit
40 base station
50-i WIRELESS COMMUNICATION DEVICE
60, 70 communication system
90 information processing device
91 communication interface
92 input/output interface
93 computing device
94 storage device
95 nonvolatile storage device
96 drive device
97 recording medium

What is claimed is:

1. A control device comprising one or more memories storing instructions and one or more processors configured to execute the instructions to:
estimate whether an influence of an interference wave that interferes with wireless communication using sound waves of a wireless communication device present underwater is continuous or transient, based on a velocity of an interference source that generates the interference wave; and
perform control to, in a case where it is estimated that the influence of the interference wave is continuous, change a use frequency used for the wireless communication by an interfered device that is a wireless communication device that is influenced by the interference wave and performs the wireless communication to an interference mitigation frequency that is a frequency capable of reducing the influence of the interference wave, and
in a case where it is estimated that the influence of the interference wave is transient, continue the use of the use frequency of the interfered device.

2. The control device according to claim 1, wherein
the influence of the interference wave is estimated to be transient in a case where the velocity of the interference source is greater than a predetermined velocity.

3. The control device according to claim 2, wherein
the influence of the interference wave is estimated to be continuous in a case where the velocity of the interference source is equal to or less than the predetermined velocity.

4. The control device according to claim 3, wherein
the influence of the interference wave is estimated to be continuous in a case where the velocity of the interference source further decreases with time.

5. The control device according to claim 1, wherein
the processors are configured to execute the instructions to estimate a position of the interference source, wherein
the velocity of the interference source is estimated by a temporal change in the position of the interference source.

6. The control device according to claim 1, wherein
the processors are configured to execute the instructions to estimate a position of the interference source, wherein
a ship serving as the interference source is estimated based on position information of the ship and the position of the interference source, and a velocity of the ship estimated as the interference source is used as the velocity of the interference source.

7.-8. (canceled)

9. A control method comprising:
estimating whether an influence of an interference wave that interferes with wireless communication using sound waves of a wireless communication device present underwater is continuous or transient, based on a velocity of an interference source that generates the interference wave; and
performing control to, in a case where it is estimated that the influence of the interference wave is continuous, change a use frequency used for the wireless communication by an interfered device that is a wireless communication device that is influenced by the interference wave and performs the wireless communication to an interference mitigation frequency that is a frequency capable of reducing the influence of the interference wave, and
in a case where it is estimated that the influence of the interference wave is transient, continue the use of the use frequency of the interfered device.

10. The control method according to claim 9, wherein
the influence of the interference wave is estimated to be transient in a case where the velocity of the interference source is greater than a predetermined velocity.

11. The control method according to claim 10, wherein
the influence of the interference wave is estimated to be continuous in a case where the velocity of the interference source is equal to or less than the predetermined velocity.

12. The control method according to claim 11, wherein
the influence of the interference wave is estimated to be continuous in a case where the velocity of the interference source further decreases with time.

13. The control method according to claim 9, further comprising
estimating a position of the interference source, wherein
the velocity of the interference source is estimated by a temporal change in the position of the interference source.

14. The control method according to claim 9, further comprising
estimating a position of the interference source, wherein
a ship serving as the interference source is estimated based on position information of the ship and the position of the interference source, and a velocity of the ship estimated as the interference source is used as the velocity of the interference source.

15. A non-transitory computer-readable recording medium that records a control program for causing a computer to implement:
an estimation function for estimating whether an influence of an interference wave that interferes with wireless communication using sound waves of a wireless communication device present underwater is continuous or transient, based on a velocity of an interference source that generates the interference wave; and
a control function for performing control to, in a case where it is estimated that the influence of the interference wave is continuous, change a use frequency used for the wireless communication by an interfered device that is a wireless communication device that is influenced by the interference wave and performs the wireless communication to an interference mitigation frequency that is a frequency capable of reducing the influence of the interference wave, and
in a case where it is estimated that the influence of the interference wave is transient, continue the use of the use frequency of the interfered device.

16. The non-transitory computer-readable recording medium that records the control program according to claim 15, wherein
the estimation function estimates that the influence of the interference wave is transient in a case where the velocity of the interference source is greater than a predetermined velocity.

17. The non-transitory computer-readable recording medium that records the control program according to claim 16, wherein
the estimation function estimates that the influence of the interference wave is continuous in a case where the velocity of the interference source is equal to or less than the predetermined velocity.

18. The non-transitory computer-readable recording medium that records the control program according to claim 17, wherein
the estimation function estimates that the influence of the interference wave is continuous in a case where the velocity of the interference source further decreases with time.

19. The non-transitory computer-readable recording medium that records the control program according to claim 15, further causing the computer to implement
an interference source position estimation function for estimating a position of the interference source, wherein
the estimation function estimates the velocity of the interference source by a temporal change in the position of the interference source.

20. The non-transitory computer-readable recording medium that records the control program according to claim 15, further causing the computer to implement
an interference source position estimation function for estimating a position of the interference source, wherein
the estimation function estimates a ship serving as the interference source based on position information of the ship and the position of the interference source, and uses a velocity of the ship estimated as the interference source as the velocity of the interference source.
